(19) United States
(12) Patent Application Publication
(10) Pub. No.: US 2013/0036160 A1
(43) Pub. Date: Feb. 7, 2013

(54) LICENSE ISSUING SYSTEM, CLIENT TERMINAL, SERVER, AND LICENSE ISSUING METHOD

(71) Applicants: Nobuaki Sasao, Chiyoda-ku (JP); Koji Ishii, Chiyoda-ku (JP)

(72) Inventors: Nobuaki Sasao, Chiyoda-ku (JP); Koji Ishii, Chiyoda-ku (JP)

(73) Assignee: NTT DOCOMO, INC., Tokyo (JP)

(21) Appl. No.: 13/641,709

(22) PCT Filed: May 11, 2011
(86) PCT No.: PCT/JP2011/060885

§ 371 Date: Oct. 17, 2012

(30) Foreign Application Priority Data
May 14, 2010 (JP) 2010-112241

(51) Int. Cl. G06F 15/16

(52) U.S. Cl. 709/203

(57) ABSTRACT

To appropriately perform a process for license issuance to a client terminal, in a license issuing system, when a client terminal fails to obtain a license from a server in spite of transmitting a license issuance request, the client terminal transmits a license issuance request including the same key information as in the initially transmitted license issuance request to the server. The server stores the key information contained in the initial license issuance request in the key information storage unit, confirms that the stored key information is the same as the key information contained in the second license issuance request, and issues a license again. The client terminal deletes the key information contained in the license issuance request after obtaining the license.

### TECHNICAL FIELD

The present invention relates to a license issuing system, a client terminal, a server, and a license issuing method for issuing a license based on a request from a client terminal.

### BACKGROUND ART

At the time of delivering pay contents such as music and video to a client terminal through a network, a method that issues a license for viewing to the client terminal that is done with accounting and delivers the contents in response to a request from the client terminal having the license is known (for example, refer to Patent Literatures 1 and 2). The process related to the issuance of a license generally ends upon receipt of a license obtainment completion report from a client terminal in a server that issues a license after issuing a license based on a request from the client terminal. Further, in the case where the client terminal fails to obtain a license for some reason, it sends a license re-issuance request to the server that issues a license, and a process of obtaining a license to be re-issued by the server is thereby performed.

### CITATION LIST

### Patent Literature

PTL 1: Japanese Unexamined Patent Application Publication No. 2003-331145
PTL 2: Japanese Unexamined Patent Application Publication

### SUMMARY OF INVENTION

### Technical Problem

However, in the case of performing the above-described typical process related to the issuance of a license, the following problem arises. Specifically, when the client terminal has obtained a license but the server has failed to receive a license obtainment completion report from the client terminal due to communication troubles or the like, the server does not receive any of the license obtainment completion report and the re-issuance request from the client terminal and therefore continues to wait for a response from the client terminal, which causes an increase in the load on the server.

Further, according to the above-described typical process related to the issuance of a license, even if the client terminal has obtained a license, the server cannot grasp the fact that the client terminal has obtained a license unless the client terminal sends the license obtainment completion report. Therefore, even when the client terminal that has already obtained a license transmits a license re-issuance request to the server, the server issues a license to the client terminal again based on the license re-issuance request. There is thus a possibility that the client terminal could illegally obtain a license.

The present invention has been accomplished to solve the above problems and an object of the present invention is thus to provide a license issuing system, a client terminal, a server, and a license issuing method in which a process related to the issuance of a license to a client terminal is performed appropriately.

### Solution to Problem

To achieve the above object, a license issuing system according to one embodiment of the present invention is a license issuing system including a client terminal and a server that transmits a license to the client terminal in response to a license issuance request from the client terminal, the client terminal including an issuance request generation means for generating a license issuance request containing information identifying a license requested for issuance to the server, information identifying the client terminal, and key information generated in response to a request for issuance of the license from the client terminal, a key information storage means for storing the key information in association with the information identifying the license generated by the issuance request generation means, and a communication means for transmitting the license issuance request to the server and receiving the license transmitted from the server based on the license issuance request, wherein the key information storage means deletes the key information stored in association with the information identifying the license when the license is received by the communication means, and wherein the communication means transmits the license issuance request again to the server when the license based on the license issuance request is not received by the communication means, and the server including a receiving means for receiving the license issuance request from the client terminal, a key information storage means for storing the key information contained in the license issuance request in association with the information identifying the license and the information identifying the client terminal, a license issuance determination means for determining whether or not to issue the license identified by the information identifying the license contained in the license issuance request to the client terminal based on the key information contained in the license issuance request from the client terminal and the key information stored in the key information storage means before receiving the license issuance request by the receiving means, and a license issuance means for issuing the license to the client terminal based on a determination result by the license issuance determination means, wherein, when the key information contained in the license issuance request from the client terminal and the key information stored in the key information storage means in association with the information identifying the license and the information identifying the client terminal match, the license issuance determination means gives an instruction to issue the license to the license issuance means, and when the key information contained in the license issuance request from the client terminal and the key information stored in the key information storage means in association with the information identifying the license and the information identifying the client terminal do not match, the license issuance determination means determines whether or not to issue the license and gives an instruction to issue the license to the license issuance means based on a result, and newly stores the key information contained in the license issuance request into the key information storage means.

Further, a client terminal according to one embodiment of the present invention is a client terminal included in a license issuing system including the client terminal and a server that transmits a license to the client terminal in response to a license issuance request from the client terminal, including an issuance request generation means for generating a license issuance request containing information identifying a license requested for issuance to the server, information identifying the client terminal, and key information generated in response to a request for issuance of the license from the client terminal, a key information storage means for storing the key information in association with the information identifying the license generated by the issuance request generation means, and a communication means for transmitting the license issuance request to the server and receiving the license transmitted from the server based on the license issuance request, wherein the key information storage means deletes the key information stored in association with the information identifying the license when the license is received by the communication means, and wherein the communication means transmits the license issuance request again to the server when the license based on the license issuance request is not received by the communication means.

Further, a server according to one embodiment of the present invention is a server in a license issuing system including a client terminal and the server that transmits a license to the client terminal in response to a license issuance request from the client terminal, including a receiving means for receiving the license issuance request transmitted from the client terminal, the license issuance request containing information identifying a license requested for issuance to the server, information identifying the client terminal, and specific key information associated with the information identifying the license, a key information storage means for storing the key information contained in the license issuance request in association with the information identifying the license and the information identifying the client terminal, a license issuance determination means for determining whether or not to issue the license identified by the information identifying the license contained in the license issuance request to the client terminal based on the key information contained in the license issuance request from the client terminal and the key information stored in the key information storage means before receiving the license issuance request by the receiving means, and a license issuance means for issuing the license to the client terminal based on a determination result by the license issuance determination means, wherein, when the key information contained in the license issuance request from the client terminal and the key information stored in the key information storage means in association with the information identifying the license and the information identifying the client terminal match, the license issuance determination means gives an instruction to issue the license to the license issuance means, and when the key information contained in the license issuance request from the client terminal and the key information stored in the key information storage means in association with the information identifying the license and the information identifying the client terminal do not match, the license issuance determination means determines whether or not to issue the license and gives an instruction to issue the license to the license issuance means based on a result, and newly stores the key information contained in the license issuance request into the key information storage means.

In the above-described license issuing system, when the client terminal fails to obtain the license despite that the client terminal has transmitted the license issuance request, the client terminal transmits the license issuance request containing the same key information as the one contained in the initially transmitted license issuance request to the server. The server stores the key information contained in the initial license issuance request in the key information storage means, confirms that the stored key information is the same as the key information contained in the second license issuance request, and issues a license again. The client terminal further deletes the key information contained in the license issuance request after obtaining the license.

As described above, in the license issuing system according to one embodiment of the present invention, the key information contained in the license issuance request is used as information that specifies the license issuance request from the client terminal. Then, when the client terminal fails to obtain the license, it is possible to determine whether the license re-issuance request that is transmitted to the server is the same request as the initial license issuance request based on whether the key information is the same or not. It is thus not necessary for the server to keep waiting for a response from the client terminal, allowing reduction of the load on the server.

Further, the client terminal deletes the key information used for the license issuance request after obtaining the license based on the license issuance request, and it is thus possible to prevent the license issuance request to be made in a dishonest manner. Therefore, in the license issuing system according to the present invention, the process related to the issuance of a license to the client terminal is performed appropriately.

The key information that is contained in the license issuance request may be a random number used when encrypting the license issuance request.

In this case, it is possible to re-issue the license with a smaller amount of information compared with the case of generating information different from the information used for the encryption as the key information.

Further, when the key information contained in the license issuance request from the client terminal and the key information stored in the key information storage means in association with the information identifying the license and the information identifying the client terminal do not match, the license issuance determination means may check whether the client terminal performs accounting related to the license identified by the information identifying the license, and when the client terminal performs the accounting, may give an instruction to issue the license to the license issuance means and newly store the key information contained in the license issuance request into the key information storage means and, when the client terminal does not perform the accounting, may cancel issuance of the license.

As described above, by making determination as to whether or not to issue a license based on whether accounting is done for the license for which the license issuance request has been sent, it is possible to issue the license without performing another accounting when the accounting is done.

Further, when the key information contained in the license issuance request from the client terminal and the key information stored in the key information storage means in association with the information identifying the license and the information identifying the client terminal do not match, the license issuance determination means may give an instruction to perform accounting to the client terminal and, when the accounting is consequently performed by the client terminal, may give an instruction to issue the license to the license issuance means and newly store the key information contained in the license issuance request into the key information storage means and, when the client terminal does not perform the accounting, may cancel issuance of the license.

As described above, by making determination as to whether or not to issue a license based on whether accounting is done for the license for which the license issuance request has been sent and, when it is the issuance request for the license on which accounting is not done, giving an instruction to perform accounting to the client terminal, it is possible to prompt the client terminal to perform accounting.

It should be noted that the present invention may be described as the invention of the license issuing method as described below, in addition to be described as the invention of the license issuing system, the client terminal and the server as described above. This is substantially the same invention and has the same effects, only that the category is different.

Specifically, a license issuing method according to one embodiment of the present invention is a license issuing method by a license issuing system including a client terminal and a server that transmits a license to the client terminal in response to a license issuance request from the client terminal, including an issuance request generation step of generating a license issuance request containing information identifying a license requested for issuance to the server, information identifying the client terminal, and key information generated in response to a request for issuance of the license from the client terminal, by an issuance request generation means of the client terminal, a key information storage step of storing the key information in association with the information identifying the license generated by the issuance request generation means into a key information storage means of the client terminal, a communication step of transmitting the license issuance request to the server and receiving the license transmitted from the server based on the license issuance request, by a communication means of the client terminal, wherein, in the key information storage step, the key information stored in the key information storage means in association with the information identifying the license is deleted when the license is received in the communication step, and wherein, in the communication step, the license issuance request is transmitted again to the server when the license based on the license issuance request is not received by the communication means, a receiving step of receiving the license issuance request from the client terminal, by a receiving means of the server, a key information storage step of storing the key information contained in the license issuance request in association with the information identifying the license and the information identifying the client terminal into a key information storage means of the server, a license issuance determination step of determining whether or not to issue the license identified by the information identifying the license contained in the license issuance request to the client terminal based on the key information contained in the license issuance request from the client terminal and the key information stored in the key information storage means before receiving the license issuance request by the receiving means, by a license issuance determination means of the server, and a license issuance step of issuing the license to the client terminal based on a determination result in the license issuance determination step, by a license issuance means of the server, wherein, in the license issuance determination step, when the key information contained in the license issuance request from the client terminal and the key information stored in the key information storage means in association with the information identifying the license and the information identifying the client terminal match, an instruction to issue the license is given to the license issuance means, and when the key information contained in the license issuance request from the client terminal and the key information stored in the key information storage means in association with the information identifying the license and the information identifying the client terminal do not match, whether or not to issue the license is determined and an instruction to issue the license is given to the license issuance means based on a result, and the key information contained in the license issuance request is newly stored into the key information storage means.

Further, a license issuing method by a client terminal according to one embodiment of the present invention is a license issuing method by a client terminal included in a license issuing system including the client terminal and a server that transmits a license to the client terminal in response to a license issuance request from the client terminal, including an issuance request generation step of generating a license issuance request containing information identifying a license requested for issuance to the server, information identifying the client terminal, and key information generated in response to a request for issuance of the license from the client terminal, by an issuance request generation means, a key information storage step of storing the key information in association with the information identifying the license generated by the issuance request generation means into a key information storage means, and a communication step of transmitting the license issuance request to the server and receiving the license transmitted from the server based on the license issuance request, by a communication means, wherein, in the key information storage step, the key information stored in the key information storage means in association with the information identifying the license is deleted when the license is received in the communication step, and wherein, in the communication step, the license issuance request is transmitted again to the server when the license based on the license issuance request is not received by the communication means.

Further, a license issuing method by a server according to one embodiment of the present invention is a license issuing method by a server included in a license issuing system including a client terminal and the server that transmits a license to the client terminal in response to a license issuance request from the client terminal, including a receiving step of receiving the license issuance request transmitted from the client terminal by a receiving means, the license issuance request containing information identifying a license requested for issuance to the server, information identifying the client terminal, and specific key information associated with the information identifying the license, a key information storage step of storing the key information contained in the license issuance request in association with the information identifying the license and the information identifying the client terminal into a key information storage means, a license issuance determination step of determining whether or not to issue the license identified by the information identifying the license contained in the license issuance request to the client terminal based on the key information contained in the license issuance request from the client terminal and the key information stored in the key information storage means before receiving the license issuance request by the receiving means, by a license issuance determination means, and a license issuance step of issuing the license to the client terminal based on a determination result in the license issuance determination step, by a license issuance means, wherein, in the license issuance determination step, when the key information contained in the license issuance request from the client terminal and the key information stored in the key information storage means in association with the information identifying the license and the information identifying the client terminal match, an instruction to issue the license is given to the license issuance means, and when the key information contained in the license issuance request from the client terminal and the key information stored in the key information storage means in association with the information identifying the license and the information identifying the client terminal do not match, whether or not to issue the license is determined and an instruction to issue the license is given to the license issuance means based on a result, and the key information contained in the license issuance request is newly stored into the key information storage means.

### Advantageous Effects of Invention

According to the present invention, a license issuing system, a client terminal, a server, and a license issuing method in which a process related to the issuance of a license by a client terminal is performed appropriately are provided.

### BRIEF DESCRIPTION OF DRAWINGS

FIG. 1 is a block diagram illustrating a configuration of a license issuing system according to one embodiment of the present invention.

FIG. 2 is a diagram showing a hardware configuration of a client terminal.

FIG. 3 is a diagram showing a hardware configuration of a server.

FIG. 4 is a diagram showing an example of information stored in a key information storage unit of the client terminal.

FIG. 5 is a diagram showing an example of information stored in a key information storage unit of the server.

FIG. 6 is a sequence chart illustrating a process related to license issuance.

FIG. 7 is a sequence chart illustrating a process related to license issuance in the case where the client terminal performs accounting.

FIG. 8 is a sequence chart illustrating a process related to license issuance in the case where the server instructs the client terminal to perform accounting.

FIG. 9 is a flowchart illustrating a process related to license issuance in the client terminal.

FIG. 10 is a flowchart illustrating a process related to license issuance in the server.

### DESCRIPTION OF EMBODIMENTS

One embodiment of the present invention will be described in detail with reference to the appended drawings. Note that, in the description of the drawings, the same elements will be denoted by the same reference symbols and redundant description will be omitted.

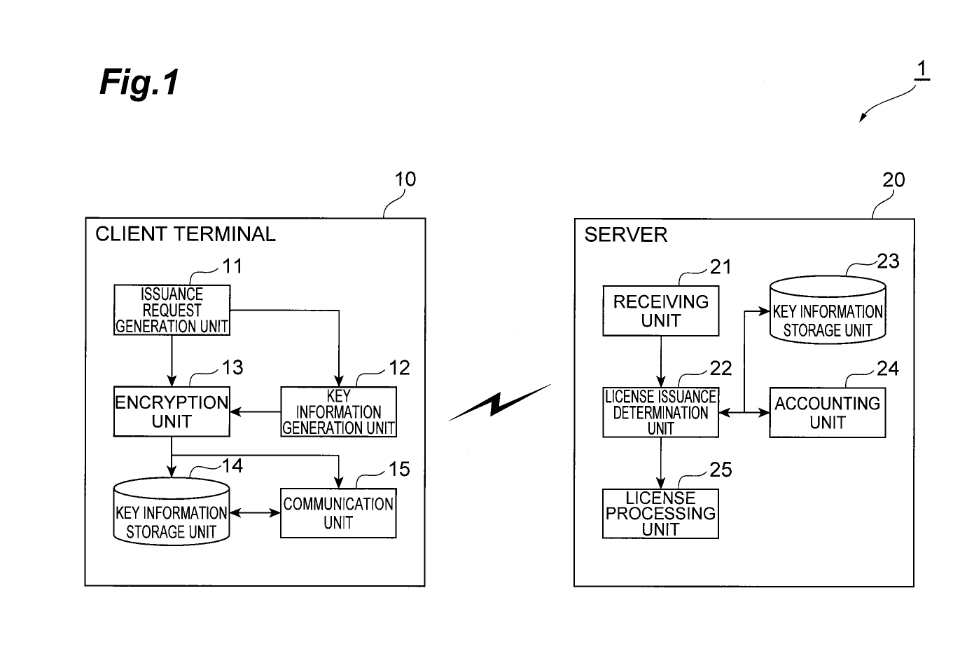

FIG. 1 is a diagram showing a configuration of a license issuing system 1 according to one embodiment of the present invention. As shown in FIG. 1, the license issuing system 1 includes a client terminal 10 and a server 20 that issues a license to the client terminal 10 in response to a license issuance request from the client terminal 10. The client terminal 10 and the server 20 are connected to be able to exchange data through a network such as the Internet, for example. Note that, although the server 20 of the license issuing system 1 generally performs a process related to the issuance of a license to a plurality of client terminals, one client terminal 10 among a plurality of client terminals and a configuration in which the server 20 performs the issuance of a license to this client terminal 10 are described by way of illustration in this embodiment.

First, a license handled in the license issuing system 1 is described hereinafter. The license is information indicating the rights to view (use) contents such as video data delivered through a network, for example, in the client terminal. When the contents are chargeable, a person who desires to view the contents obtains the license by performing accounting using the client terminal or the like in advance. Further, the contents are encrypted and protected so that the contents are viewable within the range allowed by the license in the client terminal that has obtained the license. Thus, the client terminal that has obtained the license can view the contents within the range specified by the license, and the contents are not viewable outside the specified range.

A specific example of information contained in the license is as follows. Specifically, the information includes a license ID that is ID information for uniquely identifying a license, a version number that specifies the form of a license, information related to playback and use conditions of contents, an encryption key ID that is ID information for uniquely identifying a key to encrypt contents, and an encryption key that is a key to encrypt contents. Further, the information related to playback and use conditions includes contents viewing start limit (time) and viewing end limit (time), contents viewable period, contents viewable number of times, and control information related to playback and use of contents other than the above. Note that all of the above information are not necessarily contained in the license, and some of them may be contained.

In the case where restrictions are imposed on the viewing of contents permitted by the license, the client terminal that has obtained the license checks whether the viewing is within the range restricted by the license each time viewing contents. When it is outside the range restricted by the license, the license is treated as an invalid license. Specifically, when the viewing end time limit has expired, when the number of times of viewing contents using the license exceeds the viewable number of times (the client terminal counts the number of times each time viewing contents), and when the viewing period specified by the license has elapsed (the client terminal stores the initial viewing start time and records the viewing period from that time), for example, the license becomes invalid and the contents are not viewable unless obtaining a new license.

In this embodiment, the case where the client terminal 10 requests the issuance of a license for viewing (using) contents as exemplified above, and the server 20 issues the license to the client terminal 10 in response thereto is described.

The client terminal 10 of the license issuing system 1 is described hereinafter. As shown in FIG. 1, the client terminal 10 includes an issuance request generation unit 11 (issuance request generation means), a key information generation unit 12 (issuance request generation means), an encryption unit 13 (issuance request generation means), a key information storage unit 14 (key information storage means), and a communication unit 15 (communication means).

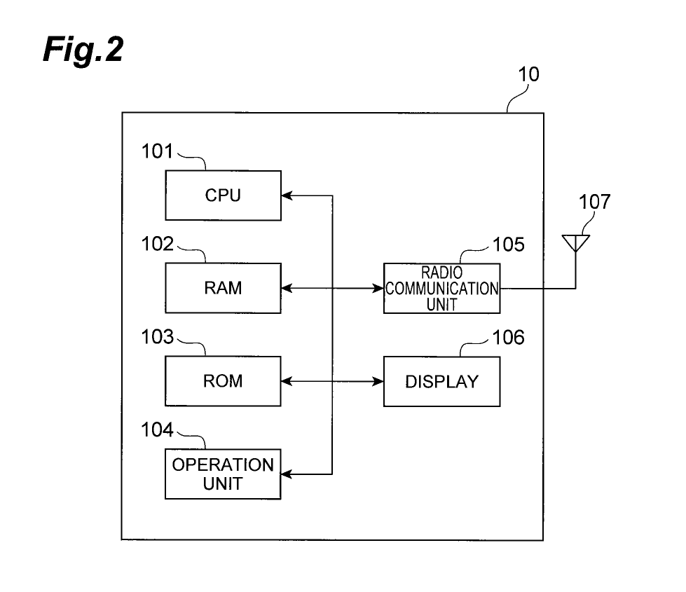

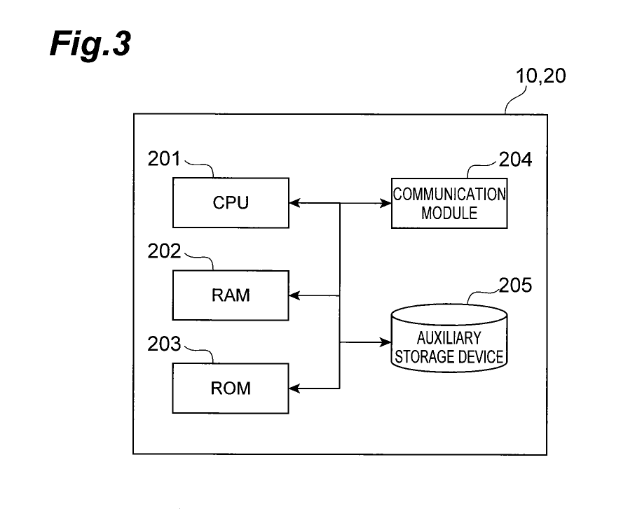

FIG. 2 is a hardware configuration diagram of the client terminal 10. The client terminal 10 is implemented as a mobile communication terminal such as a mobile phone or PDA, for example. In this case, the client terminal 10 is physically composed of a CPU (Central Processing Unit) 101, a RAM (Random Access Memory) 102, a ROM (Read Only Memory) 103, an operation unit 104, a radio communication unit 105, a display 106, and an antenna 107 as shown in FIG. 2. Further, the client terminal 10 is implemented also as a desktop computer or the like. In this case, the client terminal 10 is physically composed of a CPU 201, a RAM 202, a ROM 203, a communication module 204, and an auxiliary storage device 205 as shown in FIG. 3. Those elements operate to exercise the respective functions of the client terminal 10 described below.

Referring back to FIG. 1, the respective functional units of the client terminal 10 are described.

The issuance request generation unit 11 has a function of generating request information made up of information that identifies a license and terminal identification information that identifies the client terminal 10, which are contained in a license issuance request. The license issuance request that is transmitted from the client terminal 10 to the server 20 is transmitted from the client terminal 10 to the server 20 in order to request the issuance of a license. Specifically, the license issuance request contains a license ID as information that identifies a license, a terminal ID as information that identifies the client terminal 10 which transmits the license issuance request, and key information that is generated each time the client terminal 10 requests the issuance of the license identified by the license ID. Because the key information is generated in the key information generation unit 12, which is described later, information other than the key information in the license issuance request, which are the license ID and the terminal ID, are generated in the issuance request generation unit 11.

The generation of the request information in the issuance request generation unit 11 is started when a user of the client terminal 10 operates the client terminal 10 and gives an instruction to start the process related to the obtainment of a license. Note that the license ID may be stored in advance in the issuance request generation unit 11 in association with a license to be used by the client terminal 10 or may be specified by the user's operation of the client terminal 10. Further, the terminal ID is information that is unique to the client terminal 10 and held in advance by the client terminal 10. The terminal ID may be a telephone number, for example, when the client terminal 10 is a mobile telephone.

The request information made up of the license ID and the terminal ID which is generated by the issuance request generation unit 11 is transmitted to the encryption unit 13. Further, a notification that the process related to the license issuance request is started by the issuance request generation unit 11 is made from the issuance request generation unit 11 to the key information generation unit 12 in order to start the generation of key information in the key information generation unit 12.

The key information generation unit 12 has a function of generating key information upon generation of the license ID and the terminal ID for the license issuance request in the issuance request generation unit 11. The key information is generated each time the client terminal 10 requests the issuance of a license to the server 20, and a random number having a predetermined number of digits is used, for example. Note that the key information is not limited to a random number and it may be information of a character string or information of another kind. The key information generated in the key information generation unit 12 is transmitted to the encryption unit 13.

The encryption unit 13 has a function of encrypting the license ID and the terminal ID generated by the issuance request generation unit 11 for the license issuance request, with inclusion of the key information generated by the key information generation unit 12. The encryption in the encryption unit 13 according to this embodiment is to encrypt the license ID and the terminal ID using a key that is embedded in advance as a common key in the client terminal 10 or a key that is shared with the server at the time of initial setting. The key information is used for the purpose of making encrypted data more complex, and a random number is used, for example. By encrypting the license ID and the terminal ID with inclusion of the random number generated as the key information, decryption becomes difficult, which improves a security level. By the encryption, the license issuance request containing the license ID, the terminal ID and the key information is generated. The license issuance request generated by the encryption in the encryption unit 13 is transmitted to the communication unit 15, and the key information is transmitted to the key information storage unit 14. Note that, at the time of the encryption, so-called public key cryptosystem using a pair of keys, a public key and a private key, for encryption and decryption may be used.

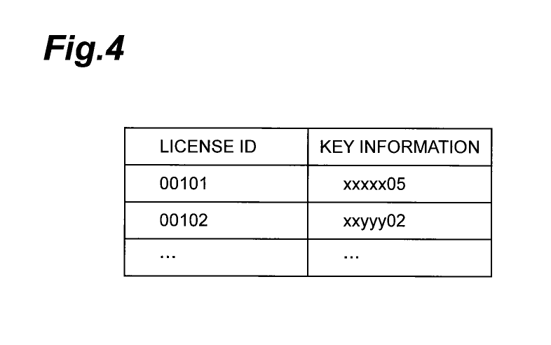

The key information storage unit 14 is placed in a secure module of the client terminal 10 and has a function of storing key information used for the encryption of a license issuance request. Specifically, as shown in FIG. 4, the license ID that identifies a license requested for issuance to the server 20 in the license issuance request and the key information are stored in association with each other. The key information stored in the key information storage unit 14 is used for transmitting the license issuance request again when some errors such as lost occur during communication and it becomes unable to obtain a license despite that the license issuance request has been sent, for example, at the time of transmitting the license issuance request or at the time of issuing a license by the server 20. The key information stored in the key information storage unit 14 is deleted from the key information storage unit 14 when a notification that the license identified by the license ID has been obtained is made from the communication unit 15.

The communication unit 15 has a function of performing communication between the client terminal 10 and the server 20 and, specifically, transmitting a license issuance request to the server 20 and receiving a license transmitted from the server 20 based on the license issuance request. Further, the communication unit 15 checks whether a license corresponding to the transmitted license issuance request is received and, when the license is not received, transmits the license issuance request again. To be specific, the communication unit 15 gives an instruction to generate the license issuance request using the license ID and the key information stored in the key information storage unit 14 (the encryption in the encryption unit 13) to the encryption unit 13 and then transmits the license issuance request generated as a result to the server 20. The process is described in detail later.

The server 20 of the license issuing system 1 is described hereinafter. The server 20 includes a receiving unit 21 (receiving means), a license issuance determination unit 22 (license issuance determination means), a key information storage unit 23 (key information storage means), an accounting unit 24, and a license processing unit 25 (license issuing means).

Further, the server 20 is physically composed of a CPU 201, a RAM 202, a ROM 203, a communication module 204, and an auxiliary storage device 205 as shown in FIG. 3. Those elements operate to exercise the respective functions of the client terminal 10 described below.

Referring back to FIG. 1, the respective functional units of the server 20 are described.

The receiving unit 21 has a function of receiving the license issuance request from the client terminal 10. The license issuance request received by the receiving unit 21 is transmitted to the license issuance determination unit 22.

The license issuance determination unit 22 has a function of determining whether or not to issue a license to the client terminal 10 in response to the license issuance request received by the receiving unit 21 based on the key information contained in the license issuance request from the client terminal 10 and the key information stored in the key information storage unit 23 before the license issuance request is received by the receiving unit 21. The determination as to whether or not to issue a license in the license issuance determination unit 22 is made on the basis of the confirmation that the license issuance request is a request from the client terminal 10 and not an illegal request and the accounting status of a user for the license. To be specific, the determination is made by referring to the key information storage unit 23, which is described later, and checking the accounting status with the accounting unit 24. When the license issuance determination unit 22 determines that a license is issuable, an instruction to issue a license is made by notifying the license ID and the terminal ID to the license processing unit 35. On the other hand, when the license issuance determination unit 22 determines that a license is not issuable, the process related to the issuance of a license is terminated, and the result is notified to the client terminal 10 according to need. The process is specifically described later.

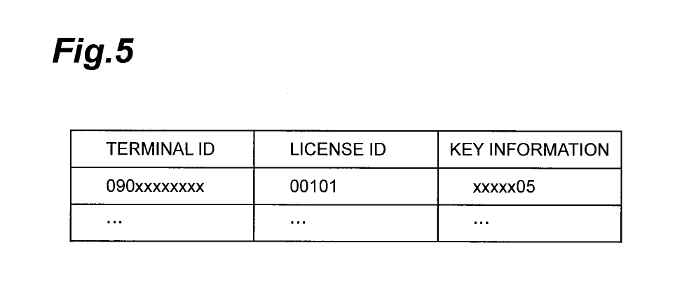

The key information storage unit 23 has a function of storing the key information contained in the license issuance request from the client terminal 10 in association with the license ID which is information that identifies a license and the terminal ID which is information that identifies the client terminal 10. Specifically, as shown in FIG. 5, the terminal ID, the license ID and the key information are stored in association with one another. The storing of information into the key information storage unit 23 is performed after decryption is done by the license issuance determination unit 22. The information stored in the key information storage unit 23 indicates that the issuance request for the license identified by the license ID has been transmitted from the client terminal 10 identified by the terminal ID to the server 20, and the encryption including the key information associated therewith has been done at that time. Note that, in the case of deleting the information stored in the key information storage unit 23, the deletion is preferably made after the information is stored sufficiently longer than the time generally needed for the process related to the issuance of a license.

The accounting unit 24 has a function of performing a process of accounting related to a license by a user. Various methods may be used as a method of accounting by a user. Specifically, an account that is not limited to a specific license may be prepared for each user, and a user makes a charge on the account, or accounting for the issuance of a specific license may be performed individually. Further, a contract for a certain term such as monthly contract or yearly contract may be made or a so-called package contract that makes a contract for several licenses may be made. In other words, the accounting unit 24 manages whether accounting related to the issuance of a license is done by some methods. When accounting related to the issuance of a license is not done by a user, the fact is notified to the license issuance determination unit 22, and thereby accounting is requested to the client terminal 10 that has transmitted the license issuance request. After that, when a user performs accounting, information is updated in the accounting unit 24 of the server 20, and then the issuance of a license becomes possible. This process is described later. Note that, although the configuration in which the server 20 includes the accounting unit 24 is described in this embodiment, an accounting server different from the server 20 may be placed, and the process related to accounting may be performed between the accounting server and the client terminal 10.

The license processing unit 25 has a function of issuing a license to the client terminal 10 based on the license ID and the terminal ID transmitted from the license issuance determination unit 22. The client terminal 10 obtains the license issued by the license processing unit 25 and thereby becomes able to use the license.

A license issuing method by the client terminal 10 and the server 20 of the license issuing system 1 is described hereinbelow.

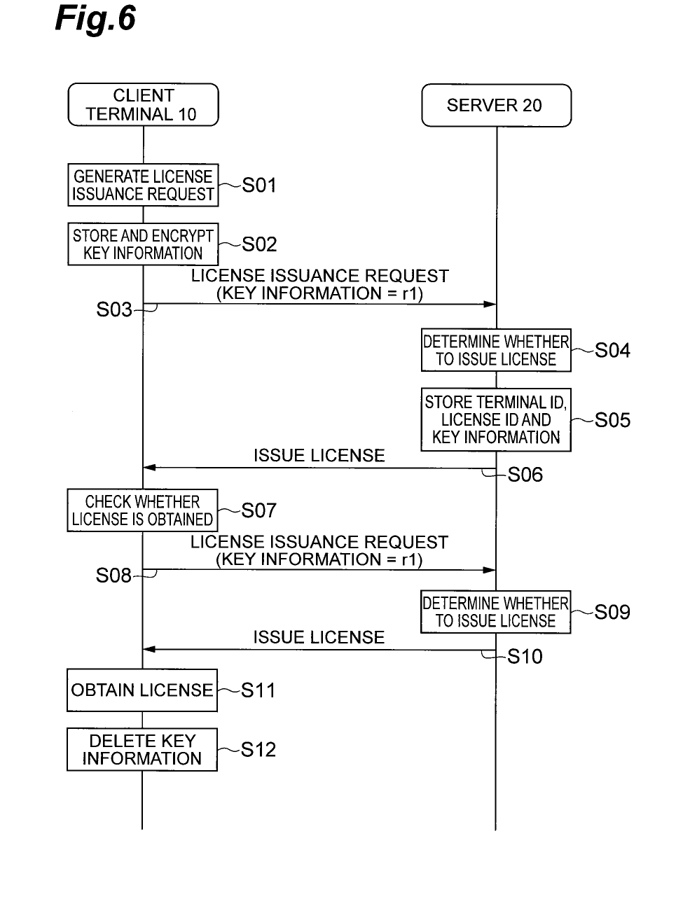

First, a basic flow for the client terminal 10 to obtain a license is described using the sequence chart illustrating the process related to the issuance of a license shown in FIG. 6. In the process related to the issuance of a license shown in FIG. 6, it is assumed that a user of the client terminal 10 is done with the accounting related to the issuance of a license, and that information is accumulated in the accounting unit 24 of the server 20.

First, the generation of request information that constitutes the license issuance request is performed in the client terminal 10 (S01, issuance request generation step). In this step, upon user's operation or the like, the issuance request generation unit 11 of the client terminal 10 generates the request information that includes the license ID of a license which the client terminal 10 requests the issuance and the terminal ID. The start of the process related to the license issuance request is notified from the issuance request generation unit 11 to the key information generation unit 12, and the request information is transmitted to the encryption unit 13. Then, the encryption unit 13 performs encryption of the request information including the key information generated by the key information generation unit 12, and the license issuance request is thereby generated (S02, issuance request generation step, key information storage step). Further, the key information used in the generation of the license issuance request is stored in association with the license ID into the key information storage unit 14. Note that the following description is based on the assumption that the key information is “r1” in FIG. 6.

Next, the license issuance request that has been transmitted from the encryption unit 13 to the communication unit 15 is transmitted from the communication unit 15 to the server 20 (S03, communication step). In this case, the license issuance request in which “r1” is used as the key information is transmitted.

In the server 20, when the license issuance request from the client terminal 10 is received by the receiving unit 21, it is transmitted to the license issuance determination unit 22, and the determination related to the issuance of a license is performed (S04, license issuance determination step). In this step, the determination is made based on whether the license ID, the terminal ID and the key information contained in the license issuance request are stored in association in the key information storage unit 23 and whether accounting related to the issuance of a license is done. To be specific, the license issuance determination unit 22 first checks that information that matches the license ID and the terminal ID and further matches the key information is not contained in the information already stored before receiving the license issuance request from the client terminal 10 by referring the key information storage unit 23. When the license ID, the terminal ID and the key information contained in the license issuance request are not stored in association, it is determined that the license issuance request transmitted from the client terminal 10 is an initial request. The license issuance determination unit 22 then checks that accounting related to a license is done by making inquiry to the accounting unit 24.

As a result, when it is determined in the license issuance determination unit 22 that a license is issuable based on the license issuance request from the client terminal 10, it stores the terminal ID, the license ID and the key information contained in the license issuance request in association with one another into the key information storage unit 23 (S05, key information storage step). On the other hand, it is determined that a license is not issuable, the subsequent process is canceled and the process ends. Note that the termination of the process may be notified to the client terminal 10. After that, an instruction to issue a license is transmitted from the license issuance determination unit 22 to the license processing unit 25, and a license corresponding to the license ID is issued to the client terminal 10 (S06, license issuance step).

In the case where the client terminal 10 has successfully obtained a license, the process of obtaining a license (S11) and deleting key information (S12) is performed; however, the case where the client terminal 10 has failed to obtain a license issued by the license processing unit 25 (S06) due to reasons such as lost during communication is described hereinbelow.

The communication unit 15 of the client terminal 10 checks whether a license is obtained when a predetermined time has elapsed from transmitting the license issuance request (S07). The predetermined time can be set based on the time needed when a typical licensing process is performed. When the license is not obtained, there is a possibility that the license issuance request does not successfully reach the server 20 or the license from the server 20 does not successfully reach the client terminal 10, and therefore the communication unit 15 encrypts the request information including the key information stored in the key information storage unit 14 again and transmits the generated license issuance request to the server 20 (S08, communication step). Because the information included in the encryption at this time is the key information stored in the key information storage unit 14, the same key information “r1” as the initial license issuance request is contained.

On the other hand, when the license issuance request from the client terminal 10 is received, by the receiving unit 21 in the server 20, it is transmitted to the license issuance determination unit 22, and the determination related to the issuance of a license is performed (S09, license issuance determination step). In this step, because the terminal ID, the license ID, and the key information have been stored in the key information storage unit 23 at the time of receiving the initial license issuance request (S05), the license issuance determination unit 22 finds that the combination of the terminal ID, the license ID, and the key information contained in the second license issuance request are stored when referring to the key information storage unit 23. Accordingly, the license issuance determination unit 22 determines that the license issuance request received for the second time (S08) is the same as the license issuance request of the first time (S03), and then an instruction to issue a license is transmitted from the license issuance determination unit 22 to the license processing unit 25 just like the first time, and a license corresponding to the license ID is issued to the client terminal 10 (S10, license issuance step).

After that, in the client terminal 10, the license is obtained by the communication unit 15 (S11, communication step). Then, a notification indicating the end of the process related to the obtainment of a license is given, together with the license ID, from the communication unit 15 to the key information storage unit 14, and the key information storage unit 14 deletes the key information based on the notification (S12, key information storage step). The obtainment of a license by the client terminal 10 thereby ends, and the license becomes available in the client terminal 10.

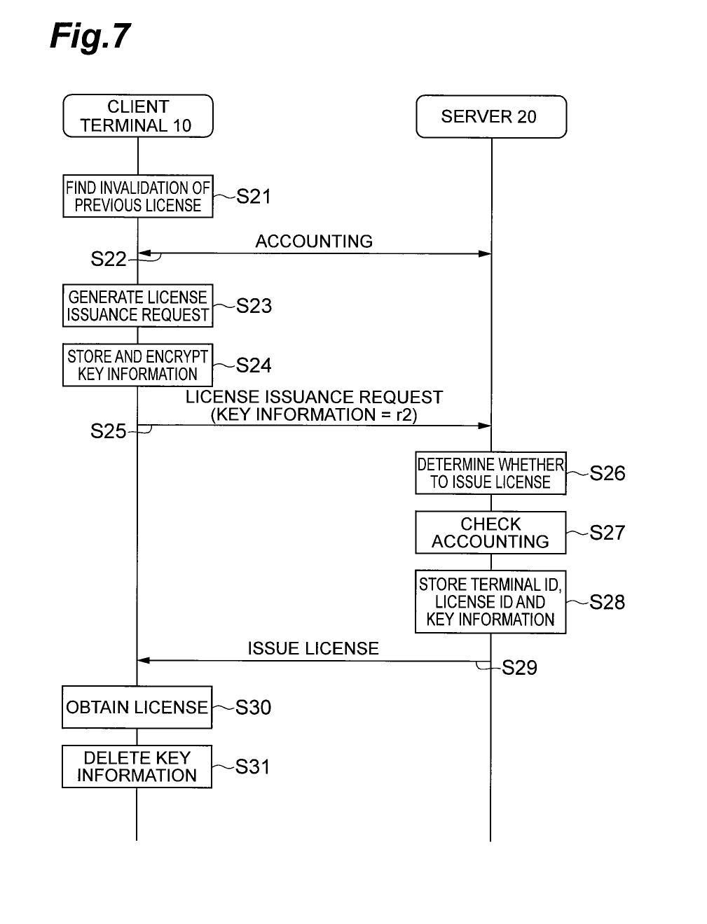

The process related to the issuance of a license in the case where the client terminal 10 performs accounting is described hereinafter with reference to the sequence chart of FIG. 7. In the process related to the issuance of a license shown in FIG. 7, the case where client terminal 10 obtains the same license again in the condition that the license obtained by the process shown in FIG. 6 is invalid due to expiration or the like and a user needs to perform accounting again is described.

First, the client terminal 10 finds that the previous license (the license obtained in the process shown in FIG. 6) is invalid (S21). In this case, because it is necessary to perform accounting before obtaining a license again, a user of the client terminal 10 performs an accounting process with the server 20 (S22). As a result, the accounting unit 24 of the server 20 records that the user of the client terminal 10 has performed accounting related to the license.

After that, in the client terminal 10, the generation of request information that constitutes the license issuance request in the issuance request generation unit 11 (S23, issuance request generation step), the generation of key information in the key information storage unit 13, the encryption in the encryption unit 13, and the storage of key information in the key information storage unit 14 (S24, issuance request generation step, key information storage step) are performed just like the process related to the issuance of a license shown in FIG. 6, and the license issuance request generated as a result is transmitted from the client terminal 10 to the server 20 (S25, communication step). Because the license issuance request transmitted in this step is different from the license issuance request shown in FIG. 6, the key information contained in the license issuance request is “r2”, which is different from “r1”.

On the other hand, when the license issuance request from the client terminal 10 is received, by the receiving unit 21 in the server 20, it is transmitted to the license issuance determination unit 22, and the determination related to the issuance of a license is performed (S26, license issuance determination step). In this step, because the terminal ID, the license ID, and the key information (“r1”) have been stored in the key information storage unit 23 at the time of receiving the initial license issuance request, the key information stored in the key information storage unit 23 and the key information (“r2”) contained in the license issuance request of this time do not match. Accordingly, the license issuance determination unit 22 checks with the accounting unit 24 whether a user of the client terminal 10 has performed accounting (S27).

Because the user has already performed accounting (S22), this is notified from the accounting unit 24. Therefore, the license issuance determination unit 22 determines that a license is issuable based on the license issuance request containing the new key information. Further, the information stored in the key information storage unit 23 is updated based on the determination result (S28). After that, a license is issued from the license processing unit 25 to the client terminal 10 (S29, license issuance step). In the client terminal 10, the license is obtained by the communication unit 15 (S30, communication step). Then, a notification indicating the end of the process related to the obtainment of a license is given, together with the license ID, from the communication unit 15 to the key information storage unit 14, and the key information storage unit 14 deletes the key information based on the notification (S31, key information storage step). The obtainment of a license by the client terminal 10 thereby ends, and the license becomes available in the client terminal 10.

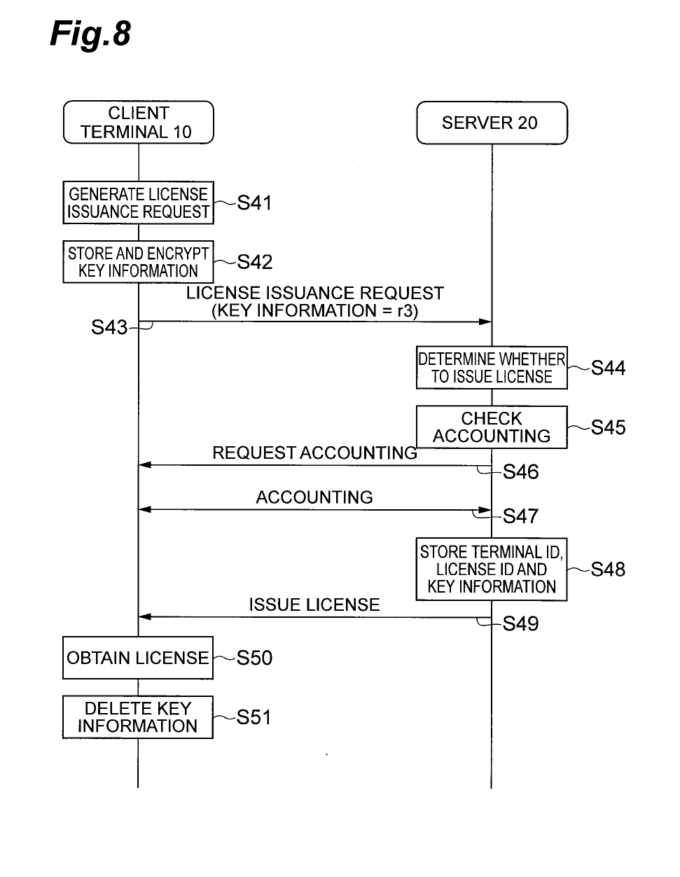

The process related to the issuance of a license in the case where the server 20 gives an instruction for accounting to the client terminal 10 is described hereinafter with reference to the sequence chart of FIG. 8. The process related to the issuance of a license shown in FIG. 8 is different from the process related to the issuance of a license shown in 7 in the following point. The point is that, after the server 20 receives a license issuance request, it gives an instruction for accounting to the client terminal 10. In other words, the accounting is not started on the initiative of the client terminal 10 but performed based on an accounting request from the server 20.

First, in the client terminal 10, the generation of request information that constitutes the license issuance request in the issuance request generation unit 11 (S41, issuance request generation step), the generation of key information in the key information storage unit 13, the encryption in the encryption unit 13, and the storing of key information in the key information storage unit 14 (S42, issuance request generation step, key information storage step) are performed just like the process related to the issuance of a license shown in FIG. 6, and the license issuance request generated as a result is transmitted from the client terminal 10 to the server 20 (S43, communication step). Because the license issuance request transmitted in this step is different from the license issuance request shown in FIG. 6, the key information contained in the license issuance request is “r3”, which is different from “r1”.

On the other hand, when the license issuance request from the client terminal 10 is received, by the receiving unit 21 of the server 20, it is transmitted to the license issuance determination unit 22, and the determination related to the issuance of a license is performed (S44, license issuance determination step). In this step, because the terminal ID, the license ID, and the key information (“r1”) have been stored in the key information storage unit 23 at the time of receiving the initial license issuance request, the key information stored in the key information storage unit 23 and the key information (“r3”) contained in the license issuance request of this time do not match. Accordingly, the license issuance determination unit 22 checks with the accounting unit 24 whether a user of the client terminal 10 has performed accounting (S45).

Because the user has not yet performed accounting, this is notified from the accounting unit 24. Based on the notification from the accounting unit 24, the license issuance determination unit 22 transmits an accounting request to the client terminal 10 (S46). An accounting process is thereby performed between a user of the client terminal 10 and the server 20 (S47).

Based on the completion of the accounting process, the license issuance determination unit 22 determines that a license is issuable based on the license issuance request that contains the new key information. Further, the key information stored in the key information storage unit 23 is updated to new key information (“r3”) based on the determination result (S48). After that, a license is issued from the license processing unit 25 to the client terminal 10 (S49, license issuance step). In the client terminal 10, the license is obtained by the communication unit 15 (S50, communication step). Then, a notification indicating the end of the process related to the obtainment of a license is given, together with the license ID, from the communication unit 15 to the key information storage unit 14, and the key information storage unit 14 deletes the key information based on the notification (S51, key information storage step). The obtainment of a license by the client terminal 10 thereby ends, and the license becomes available in the client terminal 10.

Further, the way that starts the accounting process at the initiative of the client terminal 10 as shown in FIG. 7 and the way that starts the accounting process by transmitting an accounting request from the server 20 to the client terminal 10 as shown in FIG. 8 may be combined. Further, the expiration or the like of a license used by the client terminal 10 may be managed in the server 20, and the key information stored in the key information storage unit 23 may be invalidated at the point of time when the expiration of the license comes up.

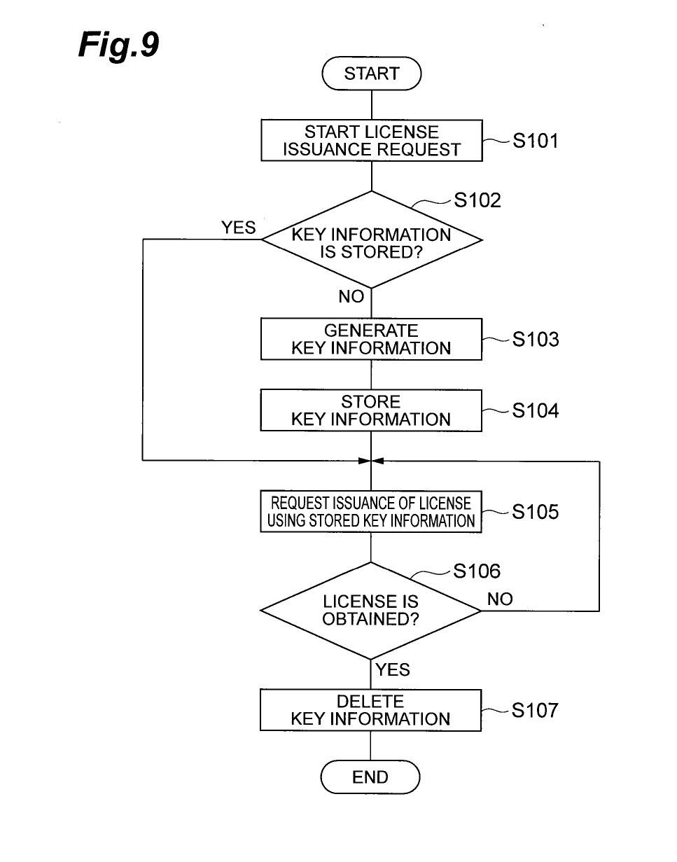

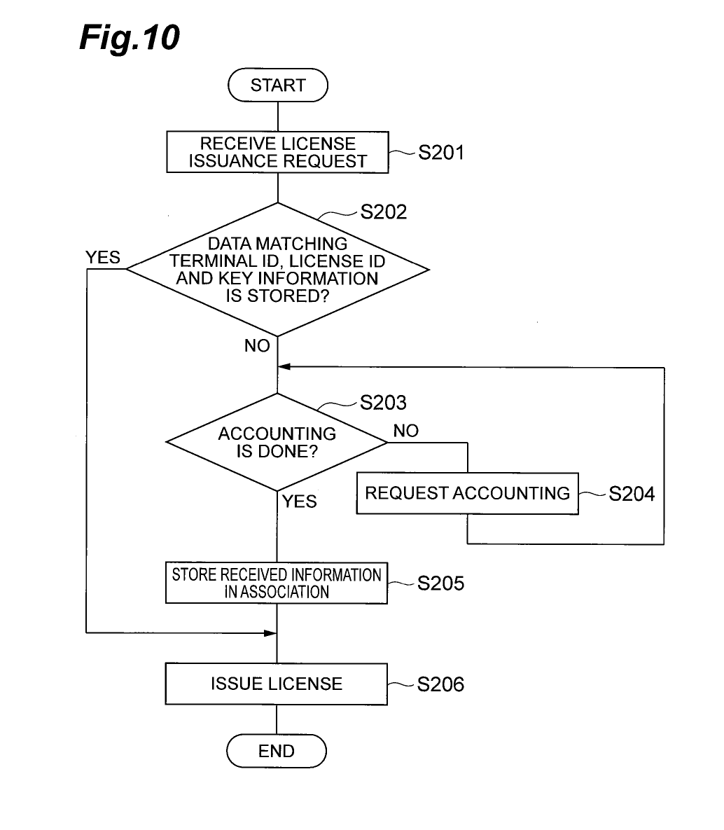

The processes performed in the client terminal 10 and the server 20, respectively, for the issuance of a license are described hereinafter with reference to FIGS. 9 and 10. This corresponds to the processes related to the issuance of a license in the license issuing system which are described earlier with reference to FIGS. 6 to 8. FIG. 9 is a flowchart illustrating a process related to license issuance in the client terminal 10. FIG. 10 is a flowchart illustrating a process related to license issuance in the server 20.

First, the process related to the issuance of a license in the client terminal 10 is described with reference to FIG. 9. First, a process related to a license issuance request is started in the client terminal 10 (S101). Next, it is checked whether key information used in the license issuance request is stored in the key information storage unit 14 in the client terminal 10 (S102). When the key information is already generated and stored in the key information storage unit 14, it is not necessary to generate the key information. On the other hand, when the key information is not stored, the key information is generated by the key information generation unit 12 (S103), and it is stored into the key information storage unit 14 through the encryption unit 13 (S104). After that, the license issuance request that is encrypted in the encryption unit 13 using the key information stored in the key information storage unit 14 (or the key information already stored in the key information storage unit 14) is transmitted from the client terminal 10 to the server 20 (S105).

Then, it is checked whether a license is issued by the server 20 and obtained by the client terminal 10 in response to the license issuance request that has been transmitted from the client terminal 10 to the server 20 (S106) and, when the license is obtained, the key information stored in the key information storage unit 14 is deleted (S107). On the other hand, when the license is not obtained, the license issuance request is transmitted again (S105). In this manner, the process related to the issuance (obtainment) of a license is performed in the client terminal 10.

Next, the process related to the issuance of a license in the server 20 is described with reference to FIG. 10. When the license issuance request from the client terminal 10 is received by the receiving unit 21 in the server 20 (S201), the license issuance request is transmitted from the receiving unit 21 to the license issuance determination unit 22. In the license issuance determination unit 22, it is checked whether data that matches the combination of the terminal ID, the license ID and the key information contained in the license issuance request is stored in the key information storage unit 23 by reference to the key information storage unit 23 (S202). When the matching data is stored in the key information storage unit 23, a license is issued by the license processing unit 25 as described later (S206).

On the other hand, when the matching data is not stored in the key information storage unit 23, it is checked whether accounting related to the license issuance is done by making inquiry to the accounting unit 24 (S203). When accounting is not done, accounting is requested to the client terminal 10 (S204). Then, when accounting related to the obtainment of a license for the client terminal 10 is performed, the terminal ID, the license ID and the key information contained in the license issuance request from the client terminal 10 are stored in association with one another into the key information storage unit 23 (S205). Then, an instruction to issue a license is transmitted to the license processing unit 25, and a license is issued by the license processing unit 25 (S206) and transmitted to the client terminal 10.

As described above, in the license issuing system 1 according to the embodiment, when the client terminal 10 fails to obtain a license despite that the client terminal 10 has transmitted a license issuance request, the client terminal 10 transmits a license issuance request that is the same as the initial license issuance request with inclusion of key information to the server 20. The server 20 stores key information contained in the initial license issuance request in the key information storage unit 23, confirms that the stored key information matches key information contained in the second license issuance request, and issues a license again. Further, the client terminal 10 deletes the key information contained in the license issuance request after obtaining the license.

Therefore, in the license issuing system 1, key information contained in the license issuance request is used as information that specifies the license issuance request from the client terminal 10, and it is possible to determine whether the second license issuance request received in the server 20 is the same request as the initial license issuance request and re-issue a license (issue a license for the second time), so that a license is issued appropriately. Further, because the license issuance request for the re-issuance of a license is determined as the same as the initial license issuance request in the server 20, it is possible to avoid that it is determined as a new license issuance request and accounting is requested.

Further, compared with the process in the license issuing system according to related art, while it has been necessary for the server to wait to see whether the client terminal has obtained a license in the system according to related art; in the license issuing system according to the embodiment, when a license is not obtained in the client terminal, a license re-issuance request is transmitted from the client terminal, and therefore a waiting time for the server to confirm the obtainment of a license by the client terminal is not needed, thus reducing the load on the server 20.

Further, because the key information used for the license issuance request is deleted after obtaining a license in the client terminal 10, it is possible to prevent the license issuance request for the second or subsequent time to be made in a dishonest manner.

Further, because the above-described license issuing system 1 uses information that has been used for the encryption in the encryption unit 13 as the key information, the re-issuance of a license can be made with a smaller amount of information compared with the case of generating information different from the information used for the encryption as the key information. Further, because data is exchanged in an encrypted form in communication between the client terminal 10 and the server 20, highly secured communication is performed between the client terminal 10 and the server 20.

Although one embodiment of the present invention is described in the foregoing, the present invention is not restricted to the above-described embodiment, and various changes and modifications may be made without departing from the scope of the invention.

For example, although the case of transmitting and receiving request information for identifying a license in an encrypted form is described above, the encryption of the license issuance request is not essential. Further, accounting is also not an essential requirement. Specifically, for contents that are viewable by obtaining a license without accounting, a process related to accounting may be skipped.

Furthermore, although information related to the encryption is used as the key information, information different from a random number related to the encryption may be used as the key information. Note that, however, the load on the server 20 is reduced when using information used for the encryption as the key information.

### REFERENCE SIGNS LIST

1 . . . license issuing system, 10 . . . client terminal, 20 . . . server, 11 . . . issuance request generation unit, 12 . . . key information protection unit, 13 . . . encryption unit, 14 . . . key information storage unit, 15 . . . communication unit, 20 . . . server, 21 . . . receiving unit, 22 . . . license issuance determination unit, 23 . . . key information storage unit, 24 . . . accounting unit, 25 . . . license processing unit

1. A license issuing system including a client terminal and a server that transmits a license to the client terminal in response to a license issuance request from the client terminal,
the client terminal comprising:
an issuance request generation unit for generating a license issuance request containing information identifying a license requested for issuance to the server, information identifying the client terminal, and key information generated in response to a request for issuance of the license from the client terminal;
a key information storage unit for storing the key information in association with the information identifying the license generated by the issuance request generation unit; and
a communication unit for transmitting the license issuance request to the server and receiving the license transmitted from the server based on the license issuance request,
wherein the key information storage unit deletes the key information stored in association with the information identifying the license when the license is received by the communication unit, and
wherein the communication unit transmits the license issuance request again to the server when the license based on the license issuance request is not received by the communication unit, and
the server comprising:
a receiving unit for receiving the license issuance request from the client terminal;
a key information storage unit for storing the key information contained in the license issuance request in association with the information identifying the license and the information identifying the client terminal;
a license issuance determination unit for determining whether or not to issue the license identified by the information identifying the license contained in the license issuance request to the client terminal based on the key information contained in the license issuance request from the client terminal and the key information stored in the key information storage unit before receiving the license issuance request by the receiving unit; and
a license issuance unit for issuing the license to the client terminal based on a determination result by the license issuance determination unit,
wherein, when the key information contained in the license issuance request from the client terminal and the key information stored in the key information storage unit in association with the information identifying the license and the information identifying the client terminal match, the license issuance determination unit gives an instruction to issue the license to the license issuance unit, and when the key information contained in the license issuance request from the client terminal and the key information stored in the key information storage unit in association with the information identifying the license and the information identifying the client terminal do not match, the license issuance determination means unit determines whether or not to issue the license and gives an instruction to issue the license to the license issuance unit based on a result, and newly stores the key information contained in the license issuance request into the key information storage unit.

2. The license issuing system according to claim 1,
wherein the key information contained in the license issuance request is a random number used when encrypting the license issuance request.

3. The license issuing system according to claim 1,
wherein, when the key information contained in the license issuance request from the client terminal and the key information stored in the key information storage unit in association with the information identifying the license and the information identifying the client terminal do not match, the license issuance determination unit checks whether the client terminal performs accounting related to the license identified by the information identifying the license, and when the client terminal performs the accounting, gives an instruction to issue the license to the license issuance unit and newly stores the key information contained in the license issuance request into the key information storage unit and, when the client terminal does not perform the accounting, cancels issuance of the license.

4. The license issuing system according to claim 1,
wherein, when the key information contained in the license issuance request from the client terminal and the key information stored in the key information storage unit in association with the information identifying the license and the information identifying the client terminal do not match, the license issuance determination unit gives an instruction to perform accounting to the client terminal and, when the accounting is consequently performed by the client terminal, gives an instruction to issue the license to the license issuance unit and newly stores the key information contained in the license issuance request into the key information storage unit and, when the client terminal does not perform the accounting, cancels issuance of the license.

5. A client terminal included in a license issuing system including the client terminal and a server that transmits a license to the client terminal in response to a license issuance request from the client terminal, comprising:
an issuance request generation unit for generating a license issuance request containing information identifying a license requested for issuance to the server, information identifying the client terminal, and key information generated in response to a request for issuance of the license from the client terminal;
a key information storage unit for storing the key information in association with the information identifying the license generated by the issuance request generation unit; and
a communication unit for transmitting the license issuance request to the server and receiving the license transmitted from the server based on the license issuance request,
wherein the key information storage unit deletes the key information stored in association with the information identifying the license when the license is received by the communication unit, and
wherein the communication unit transmits the license issuance request again to the server when the license based on the license issuance request is not received by the communication unit.

6. A server in a license issuing system including a client terminal and the server that transmits a license to the client terminal in response to a license issuance request from the client terminal, comprising:
a receiving unit for receiving the license issuance request transmitted from the client terminal, the license issuance request containing information identifying a license requested for issuance to the server, information identifying the client terminal, and specific key information associated with the information identifying the license;
a key information storage unit for storing the key information contained in the license issuance request in association with the information identifying the license and the information identifying the client terminal;
a license issuance determination unit for determining whether or not to issue the license identified by the information identifying the license contained in the license issuance request to the client terminal based on the key information contained in the license issuance request from the client terminal and the key information stored in the key information storage unit before receiving the license issuance request by the receiving unit; and
a license issuance unit for issuing the license to the client terminal based on a determination result by the license issuance determination unit,
wherein, when the key information contained in the license issuance request from the client terminal and the key information stored in the key information storage unit in association with the information identifying the license and the information identifying the client terminal match, the license issuance determination unit gives an instruction to issue the license to the license issuance unit, and when the key information contained in the license issuance request from the client terminal and the key information stored in the key information storage unit in association with the information identifying the license and the information identifying the client terminal do not match, the license issuance determination unit determines whether or not to issue the license and gives an instruction to issue the license to the license issuance unit based on a result, and newly stores the key information contained in the license issuance request into the key information storage unit.

7. A license issuing method by a license issuing system including a client terminal and a server that transmits a license to the client terminal in response to a license issuance request from the client terminal, comprising:
an issuance request generation step of generating a license issuance request containing information identifying a license requested for issuance to the server, information identifying the client terminal, and key information generated in response to a request for issuance of the license from the client terminal, by an issuance request generation unit of the client terminal;
a key information storage step of storing the key information in association with the information identifying the license generated by the issuance request generation unit into a key information storage unit of the client terminal;
a communication step of transmitting the license issuance request to the server and receiving the license transmitted from the server based on the license issuance request, by a communication unit of the client terminal;
wherein, in the key information storage step, the key information stored in the key information storage unit in association with the information identifying the license is deleted when the license is received in the communication step, and
wherein, in the communication step, the license issuance request is transmitted again to the server when the license based on the license issuance request is not received by the communication unit,
a receiving step of receiving the license issuance request from the client terminal, by a receiving unit of the server;
a key information storage step of storing the key information contained in the license issuance request in association with the information identifying the license and the information identifying the client terminal into a key information storage unit of the server;
a license issuance determination step of determining whether or not to issue the license identified by the information identifying the license contained in the license issuance request to the client terminal based on the key information contained in the license issuance request from the client terminal and the key information stored in the key information storage unit before receiving the license issuance request by the receiving unit, by a license issuance determination unit of the server; and
a license issuance step of issuing the license to the client terminal based on a determination result in the license issuance determination step, by a license issuance unit of the server,
wherein, in the license issuance determination step, when the key information contained in the license issuance request from the client terminal and the key information stored in the key information storage unit in association with the information identifying the license and the information identifying the client terminal match, an instruction to issue the license is given to the license issuance unit, and when the key information contained in the license issuance request from the client terminal and the key information stored in the key information storage unit in association with the information identifying the license and the information identifying the client terminal do not match, whether or not to issue the license is determined and an instruction to issue the license is given to the license issuance unit based on a result, and the key information contained in the license issuance request is newly stored into the key information storage unit.

8. A license issuing method by a client terminal included in a license issuing system including the client terminal and a server that transmits a license to the client terminal in response to a license issuance request from the client terminal, comprising:
an issuance request generation step of generating a license issuance request containing information identifying a license requested for issuance to the server, information identifying the client terminal, and key information generated in response to a request for issuance of the license from the client terminal, by an issuance request generation unit;
a key information storage step of storing the key information in association with the information identifying the license generated by the issuance request generation unit into a key information storage unit; and
a communication step of transmitting the license issuance request to the server and receiving the license transmitted from the server based on the license issuance request, by a communication unit,
wherein, in the key information storage step, the key information stored in the key information storage unit in association with the information identifying the license is deleted when the license is received in the communication step, and
wherein, in the communication step, the license issuance request is transmitted again to the server when the license based on the license issuance request is not received by the communication unit.

9. A license issuing method by a server included in a license issuing system including a client terminal and the server that transmits a license to the client terminal in response to a license issuance request from the client terminal, comprising:
a receiving step of receiving the license issuance request transmitted from the client terminal by a receiving unit, the license issuance request containing information identifying a license requested for issuance to the server, information identifying the client terminal, and specific key information associated with the information identifying the license;
a key information storage step of storing the key information contained in the license issuance request in association with the information identifying the license and the information identifying the client terminal into a key information storage unit;
a license issuance determination step of determining whether or not to issue the license identified by the information identifying the license contained in the license issuance request to the client terminal based on the key information contained in the license issuance request from the client terminal and the key information stored in the key information storage unit before receiving the license issuance request by the receiving unit, by a license issuance determination unit; and
a license issuance step of issuing the license to the client terminal based on a determination result in the license issuance determination step, by a license issuance unit,
wherein, in the license issuance determination step, when the key information contained in the license issuance request from the client terminal and the key information stored in the key information storage unit in association with the information identifying the license and the information identifying the client terminal match, an instruction to issue the license is given to the license issuance unit, and when the key information contained in the license issuance request from the client terminal and the key information stored in the key information storage unit in association with the information identifying the license and the information identifying the client terminal do not match, whether or not to issue the license is determined and an instruction to issue the license is given to the license issuance unit based on a result, and the key information contained in the license issuance request is newly stored into the key information storage unit.
